(19) United States
(12) Patent Application Publication
(10) Pub. No.: US 2026/0004166 A1
(43) Pub. Date: Jan. 1, 2026

(54) Artificial Intelligence Service(s) in a Distributed Cloud Computing Network Including Function Calling

(71) Applicant: Cloudflare, Inc., San Francisco, CA (US)

(72) Inventors: Harley Turan, London (GB); Michelle Chen, New York, NY (US); Michael Hart, New York, NY (US); Dhravya Shah, Tempe, AZ (US); Jesse Kipp, Austin, TX (US)

(21) Appl. No.: 19/251,619

(22) Filed: Jun. 26, 2025

Related U.S. Application Data
(60) Provisional application No. 63/664,669, filed on Jun. 26, 2024.

(51) Int. Cl. G06N 5/04

(52) U.S. Cl. CPC G06N 5/04

(57) ABSTRACT

A compute server of a distributed cloud computing network receives an inference request. The inference request triggers execution of code that is related to an AI application that interacts with the inference request and causes its input to be run through an AI model. Helper code executing on the compute server transmits an inference request to the AI model, where this inference request includes a prompt and one or more function definitions, and where the AI model is executing in the same datacenter as the compute server. The helper code receives a result of the AI model executing the inference request, where it includes structured data for calling a function. The helper code calls the function using the structured data. The helper code receives a response to the called function. The code processes a response to the inference request based at least on the received response to the called function.

### CROSS-REFERENCE TO RELATED APPLICATIONS

This application claims the benefit of U.S. Provisional Application No. 63/664,669, filed Jun. 26, 2024, which is hereby incorporated by reference.

### FIELD

Embodiments of the invention relate to the field of cloud computing and artificial intelligence; and more specifically, to artificial intelligence service(s) in a distributed cloud computing network including function calling.

### BACKGROUND

Artificial Intelligence (AI) is widely used for many different applications. AI can include generative AI and predictive AI. The use of AI includes training a model and performing inference with the trained model. Generative AI, such as large language models, are typically trained on very large datasets (e.g., scraping the entire internet) using specialized hardware such as graphics processing units (GPUs). Generative AI can be used for generating text, generating images, and/or generating video. Predictive AI is typically trained on a smaller dataset compared to a generative AI model and can be used for anomaly detection and categorization. Predictive AI can often be performed on central processing units (CPUs) as opposed to GPUs.

Cloud based networks may include multiple servers that are geographically distributed. The servers may be part of a content delivery network (CDN) that caches or stores content at the servers to deliver content to requesting clients with less latency due, at least in part, to the decreased distance between requesting clients and the content. Serverless computing is a method of providing backend services on an as-used basis. A serverless provider allows users to write and deploy code without the hassle of worrying about the underlying infrastructure. Despite the name serverless, physical servers are still used, but developers do not need to be aware of them. Many serverless computing environments offer database and storage services, and some allow for code to be executed on the edge of the network and therefore close to the clients.

AI models generally do not have the ability to query or modify external data. Function calling in the context of AI models allows users or client applications to leverage an AI model to intelligently generate structured outputs that can then be passed to a function call. This function call can then be used to query or modify external data. To further standardize the communication between AI models and external data sources or other tools, protocols such as the Model Context Protocol (MCP) and other open standards are being developed. MCP, for example, aims to provide a common framework for defining how AI models discover and call external tools or modify external data.

Conventionally, function calling requires multiple back-and-forth requests passing through the network to get to the final output. The first network communication is typically from the user to the application server, with the prompt or question. The second network communication is from the application server to the AI inference provider and includes the prompt and an array of functions or tools. These functions or tools are not the actual code functions, but rather descriptions of functions and their input parameters. The AI model parses the user's request and intelligently selects the right function for answering the user's prompt. The AI model structures data in the format described by the arguments of the function and returns a structured answer to the application server (e.g., in JSON format) for the function execution, which is the third network communication. The application server then needs to execute the function. If the function is an external API call, the application server makes the call to the external API, which is the fourth network communication. The application server receives the answer from the external API, which is the fifth network communication. After the function is executed, the application server sends the output to the AI Model, which is the sixth network communication. The AI model receives the output, parses and rewrites the response in natural language, and transmits the response back to the application server, which is the seventh network communication. The application server returns the response back to the user, which is the eight network communication. Each network communication increases latency.

### SUMMARY

A compute server of a distributed cloud computing network receives an inference request. The inference request triggers execution of code that is related to an AI application that interacts with the inference request and causes its input to be run through an AI model. Helper code executing on the compute server transmits an inference request to the AI model, where this inference request includes a prompt and one or more function definitions, and where the AI model is executing in the same datacenter as the compute server. The helper code receives a result of the AI model executing the inference request, where it includes structured data for calling a function. The helper code calls the function using the structured data. The helper code receives a response to the called function. The code processes a response to the inference request based at least on the received response to the called function.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary system for providing AI services in a distributed cloud computing network including function calling, according to an embodiment.

FIG. 2 illustrates an example of the function calling according to embodiments described herein.

FIG. 3 is a flow diagram that illustrates exemplary operations for processing inference requests at a distributed cloud computing network according to an embodiment.

FIG. 4 illustrates a block diagram for an exemplary data processing system that may be used in some embodiments.

### DESCRIPTION OF EMBODIMENTS

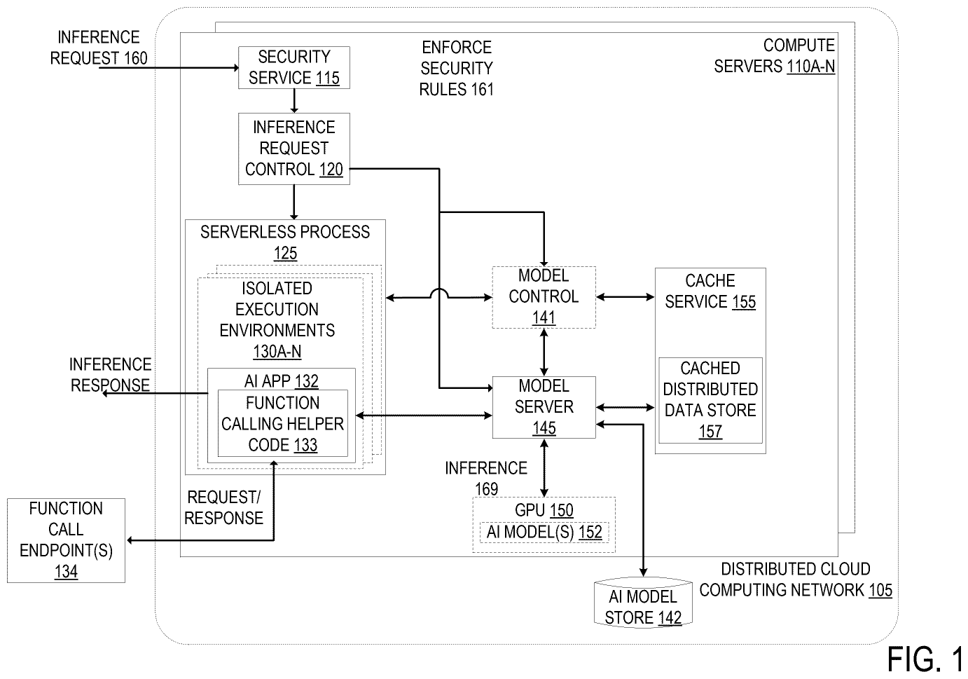

FIG. 1 illustrates an exemplary system for providing AI service(s) in a distributed cloud computing network including function calling, according to an embodiment. The distributed cloud computing network 105 includes the compute servers 110A-N. The compute servers 110A-N can be part of multiple datacenters. There may be hundreds to thousands of compute servers. Each datacenter can also include one or more control servers, one or more DNS servers, and/or one or more other pieces of network equipment such as router(s), switch(es), and/or hub(s). Each compute server within a datacenter may process network traffic (e.g., TCP, UDP, HTTP/S, SPDY, FTP, TCP, UDP, IPSec, SIP, or other IP protocol traffic).

In an embodiment, a proper subset of the compute servers 110A-N includes specialized hardware for training an AI model and/or performing inference such as one or more GPUs or neural processing units (NPUs). In such an embodiment, other ones of the compute servers 110A-N do not include such specialized hardware but may perform training and/or inference using CPUs. In another embodiment, each of the compute servers 110A-N of the distributed cloud computing network 105 includes specialized hardware for training AI models and/or performing inference.

The distributed cloud computing network 105 includes the AI model store 142, which is a repository for AI models that can be used on the distributed cloud computing network 105. The AI model store 142 may be a distributed data store provided by the distributed cloud computing network 105. The AI model store 142 may store different pretrained models with different sizes and different specializations. For example, the AI model store 142 may have one or more models for text classification, image classification, large language models, embedding models, translation models, code generation models, sentiment analysis models, and/or domain-specific models (e.g., models for medical information, models for legal information). As another example, the AI model store 142 can store multiple models of the same family of models with different parameter sizes. As another example, the AI model store 142 can store the same model at different quantization levels. The AI model store 142 can include models that are uploaded by customers (which may be private to those customers), provided by third parties, and/or provided by the provider of the distributed cloud computing network 105. A model uploaded by a customer may be trained on the distributed cloud computing network 105 or trained externally to the distributed cloud computing network 105. One or more of the models in the AI model store 142 may be used for function calling.

The model server 145 handles loading the models, including fetching the AI models from the AI model store 142 and/or from an external AI model repository (external to the distributed cloud computing network 105). The model server 145 manages the execution of the AI models on the distributed cloud computing network 105. The model server 145 can provide scheduling of the inference operations on the hardware (e.g., CPU and/or GPU). The model server 145 may provide metrics (e.g., inference request metrics, GPU metrics, and/or CPU metrics). The model server 145 may use a client-server model where clients of the model server 145 make requests of the model server 145. As will be described in greater detail, an AI application executing on the distributed cloud computing network 105 may be a client of the model server 145. Requests can be received at the model server 145 through an API or other communication mechanism (e.g., HTTP/REST, gRPC). In an embodiment, each of the compute servers 110A-N that executes AI models has an instance of the model server 145.

The distributed cloud computing network 105 receives inference requests such as the inference request 160. An inference request includes input or reference to input that is provided to an AI model for performing an inference operation. Such input may include text, image(s), video(s), and/or audio. The inference requests may be for AI model(s) that are executed internally on the distributed cloud computing network 105 (e.g., provided by the AI model store 142).

An inference request may be received at the distributed cloud computing network 105 in various ways. As an example, the inference request may be received at an API provided by the distributed cloud computing network 105. As another example, the inference request may be received at a webserver of the distributed cloud computing network 105. As another example, the inference request may be received due to a client device being configured to transmit all traffic to the distributed cloud computing network 105. For example, an agent on the client device (e.g., a VPN client) may be configured to transmit traffic to the distributed cloud computing network 105. As another example, a browser extension or file can cause the traffic to be transmitted to the distributed cloud computing network 105. In any of the above examples, a particular inference request may be received at a particular datacenter that is determined to be closest to the transmitting client device in terms of routing protocol configuration (e.g., Border Gateway Protocol (BGP) configuration) according to an anycast implementation as determined by the network infrastructure (e.g., router(s), switch(es), and/or other network equipment between the transmitting client device and the datacenters) or by a geographical load balancer.

An inference request that is received can trigger the execution of code at a compute server 110. The code can also be triggered by other trigger events, such as a predefined scheduled time, an alarm condition being met, an external event such as a receipt of an email, text message, or other electronic communication, or a message being sent to a queue system. The code may be third-party code written or deployed by a customer of the distributed cloud computing network and/or first-party code written or deployed by the provider of the distributed cloud computing network. The code may be part of a serverless application. The code can be, for example, a piece of JavaScript or other interpreted language, a WebAssembly (WASM) compiled piece of code, or other compiled code. In an embodiment, the code is compliant with the W3C standard ServiceWorker API. The code is typically executed in a runtime on a compute server and is not part of a webpage or other asset of a third-party. In an embodiment, the code can be executed at any of the compute servers. The code is sometimes referred herein as an AI application.

In an embodiment, each AI application is run in an isolated execution environment, such as run in an isolate of the V8 JavaScript engine. Thus, as illustrated in FIG. 1, a compute server 110 includes the isolated execution environments 130A-N that each execute a separate AI application 132. The isolated execution environments 130A-N on a compute server can be run within a single process (the serverless process 125). This single process can include multiple execution environments at the same time, and the process can seamlessly switch between them. Code in one execution environment cannot interfere with code running in a different execution environment, despite being in the same process. The execution environments are managed in user-space rather than by an operating system. Each execution environment uses its own mechanism to ensure safe memory access, such as preventing the code from requesting access to arbitrary memory (restricting its use to the objects it has been given) and/or interpreting pointers within a private address space that is a subset of an overall address space. In an embodiment, the code is not executed using a virtual machine or a container. However, in other embodiments, the code is executed using a virtual machine or a container.

The distributed cloud computing network 105 may include an API for interacting with AI models. This API is referred to herein as a model server API. For example, an API call may be used for transmitting an inference request to a model server. The model server API may also be used to retrieve information about the models such as a listing of the available models, details of the models, and/or status of the models (e.g., whether they are loaded, where they are loaded).

As described earlier, in an embodiment, the distributed cloud computing network 105 executes models internally on the network. In such an embodiment, a customer of the distributed cloud computing network 105 can deploy their own custom AI model to the distributed cloud computing network 105, configure and use AI model(s) provided by the provider of the distributed cloud computing network 105, and/or deploy a third-party model to the distributed cloud computing network 105. The models that are deployed may be pre-trained elsewhere and/or trained at the distributed cloud computing network 105.

Although not illustrated in FIG. 1, the distributed cloud computing network 105 can include a control server that provides a set of tools and interfaces for a customer to, among other things, deploy and/or configure AI models for execution in the distributed cloud computing network 105 and/or configure settings for external AI model execution. As an example of deploying and configuring an AI model for execution in the distributed cloud computing network 105, the customer may use the control server to configure the runtime environment; upload a custom AI model; and/or upload and/or write the AI application 132. The AI application 132 may include code for interacting with the inference request (e.g., get the content of the inference request such as text, image, audio, video, etc.); define the model input structure (e.g., construct a tensor with the input date); cause the input to be run through the AI model; and structure and send the response depending on the result of the model. The customer may use the control server to configure function calling including defining one or more functions and the function code that is to be executed.

The function(s) can be used to perform various actions. As an example, a function can be used for data retrieval (e.g., getting the real-time weather data for a specific location), API interaction (e.g., translating text from one language to another, retrieving data from an external web service or third-party API), mathematical calculations, database queries (e.g., SQL query on a database), file manipulation (e.g., creating or editing a document editing file, a spreadsheet, a presentation, a graphics file, a notetaking file, a video file, an audio file, and/or other type of file), communication (e.g., create or edit a message, an email, a social networking post). The entity that performs the function may be internal or external to the distributed cloud computing network 105.

The AI application 132 may include the function calling helper code 133 or a reference to the function calling helper code 133. The function calling helper code 133 is used for performing function calling. It interacts with the AI model passing it the function definition(s) and executes the function code. The action taken by the function code depends on how it is written. Executing the function code may include transmitting a request (e.g., an HTTP request) to an endpoint that is external to the distributed cloud computing network 105 and receiving a response (e.g., an HTTP response) from the endpoint. As another example, executing the function code may include writing to a database, which can be internal to the distributed cloud computing network 105 or external to the distributed cloud computing network 105. As another example, executing the function code may include manipulating a file (e.g., creating or editing a document editing file, a spreadsheet, a presentation, a graphics file, a notetaking file, a video file, and/or an audio file). As another example, executing the function code may include manipulating data at an application (e.g., creating or editing data for: a communication application (e.g., a messaging application, a social networking application, a video calling application, an email application); a productivity application (e.g., note taking, to-do list applications, workflow automation application, time tracking application); a customer relationship management application; a development application (e.g., an issue tracker application, a source code management deployment application); an IT or security application; and/or an analytics application). As shown in FIG. 1, the function calling helper code 133 may transmit requests and receive responses to and from the function call endpoint(s) 134.

The function calling helper code 133 can reduce the number of request/response pairs that are sent across the network as compared to conventional function calling. The function calling helper code 133 also abstracts the code necessary to interact with the AI model from the customer. The customer provides the function definition(s) and the function code that is to be executed but does not need to configure the interaction with the AI model. The function calling helper code 133 may handle multiple function calls. The function calling helper code 133 may handle recursive calls to answer the inference request (e.g., find the user's location and give me the temperature there). The function calling helper code 133 may validate the response from the AI model, and/or stream the final response.

The function calling helper code 133 may be configured to take in a specification or library and automatically create the function definitions. Thus, instead of a customer needing to configure the API endpoints from the specification or library, the function calling helper code 133 may take in the specification or library (as configured by the customer) and automatically generate the function definitions that call API endpoints that are needed for the function calls. As an example, the customer may provide an identifier (e.g., a URL) or content of an OpenAPI specification and the function calling helper code 133 (or other code in the distributed cloud computing network) automatically creates the function definitions that call API endpoints that are defined in that OpenAPI specification. The customer can also provide configuration to narrow the function definitions created from such a specification to one or more specific pathnames of the specification and can provide overrides for specific endpoints using a matching function. These overrides can include headers, body, query/path parameters. As an example, the function calling helper code 133 may be configured to match requests only to a certain endpoint of the specification or add authorization headers for requests to a particular host.

In some examples, the AI application 132 can implement a standardized framework, such as a Model Context Protocol (MCP), for integrating AI applications with external tools and data sources. MCP operates using a client-server model, where an MCP client can first discover tools or data sources available from a MCP server and then make requests to invoke specific tools. An MCP server, for example, might expose tools to interact with third-party APIs, internal or external databases, developer tools, enterprise systems, and the like.

In the MCP example, the AI application 132, together with function calling helper code 133, can act as an MCP client. The associated MCP servers are implemented by the function call endpoint(s) 134, which expose tools for MCP clients to access. The function call endpoint(s) 134 can be applications running in computing environments external to the distributed cloud computing network 105 or can be applications running in separate isolated execution environments 130A-N of the distributed cloud computing network 105. The AI application 132 (acting as a MCP client) receives inference requests 160 (such as a request from an AI model chat interface, developer tool, or other type of application) and uses the co-located AI model 152 to interpret the request, determine the need for one or more available tools, and sends invocation calls to the appropriate function call endpoint 134 (e.g., acting as an MCP server) to execute the function.

The AI model involved in the function calling is executing in the same datacenter as the AI application 132. The AI model may be executing on the same compute server as the AI application 132. The call to the AI model may be done in the same execution environment as the AI application 132 (e.g., within the same isolate of the V8 JavaScript engine, within the same container, and/or within the same virtual machine). In such a case, the AI model inference call is co-located with the function execution call itself.

As illustrated in FIG. 1, the distributed cloud computing network 105 may perform one or more security services (represented by the security service 115) on each inference request. The security services may include DDOS protection, secure session (SSL/TLS) support, web application firewall, access control, compliance, zero-trust policies, data loss prevention (DLP), detection of suspicious or undesired model inputs and undesired response content (“jailbreak detection”), and/or rate limiting.

By way of example, a customer can define requirements for accessing an AI application (e.g., the AI application 132) running on the distributed cloud computing network 105. These requirements may be based on identity-based rules and/or non-identity based rules. An identity-based access rule is based on the identity information associated with the user making the request (e.g., username, email address, etc.). Example rule selectors that are identity-based include access groups, email address, and emails ending in a specified domain. For instance, an identity-based access rule may define email addresses or groups of email addresses (e.g., all emails ending in @example.com) that are allowed and/or not allowed. A non-identity based access rule is a rule that is not based on identity. Examples include rules based on location (e.g., geographic region such as the country of origin), device posture, time of request, type of request, IP address, multifactor authentication status, multifactor authentication type, type of device, type of client network application, whether the request is associated with an agent on the client device, an external evaluation rule, and/or other layer 3, layer 4, and/or layer 7 policies.

As another example, a customer can define rate limit(s) for the number of inference requests processed by an AI application running on the distributed cloud computing network 105. The rate limit(s) may be applicable per model or per application. If the rate limit has been exceeded, the distributed cloud computing network 105 may drop the inference request or put it in a queue.

As another example, a customer can define an estimated budget for running inference operations on the distributed cloud computing network.

As another example, the customer can enable detection of inputs designed to detect undesired responses. Both the customer and the provider of the distributed cloud computing network 105 may have a list of words or input patterns used to generate undesired responses. The provider of the distributed cloud computing network 105 may also use an additional AI model to measure the sentiment or classify the input or response of an ML model and log or block the request as configured by customer policy.

After enforcing the security rules 161, the inference request 160 is processed by the inference request control 120. The inference request control 120 determines where the request will be next processed. In the example shown in FIG. 1, the inference request control 120 determines whether the inference request is to be processed by the AI application 132 or by the model server 145. For example, if the inference request 160 is an API call to the model server 145, the inference request control 120 routes the inference request to the model server 145. If the inference request 160 triggers the execution of the AI application 132, the inference request control 120 routes the inference request to the serverless process 125. For example, the inference request control 120 may include a script that determines whether the inference request is to be handled by the AI application 132. Such a script can determine that the request triggers execution of the AI application 132 by matching the zone to a predetermined matching pattern that associates the AI application 132 with the predetermined matching pattern. The inference request control 120 annotates the inference request with an identifier of the AI application 132 (as determined by a script mapping table) and forwards the inference request to the serverless process 125.

The AI application 132 can take various actions depending on how it is written. As an example, the AI application 132 can run the input of the inference request 160 to one or more models that are internal to the distributed cloud computing network 105 (e.g., a custom model of the customer, a third-party model that is deployed on the distributed cloud computing network 105, and/or a model provided by the distributed cloud computing network 105). The AI application 132 can further take the result from the model(s) and take further action(s).

With respect to the AI application 132, to run a model internally to the distributed cloud computing network 105, the AI application 132 calls the model through the model server 145. Inference requests can be received at the model server 145 through an API or other communication mechanism (e.g., HTTP/REST, gRPC). In addition to, or in lieu of running an AI application 132, a model server API can be provided that allows any application, including those external to the distributed cloud computing network 105, to call the model through the model server 145. The model server 145 handles loading the models including fetching the AI models from the AI model store 142. For instance, the model server 145 handles loading the AI model(s) 152 on the GPU 150 (or other hardware). The model server 145 performs the inference operation 169 using hardware of a compute server 110 such as a GPU or NPU.

The model server 145 can (e.g., if configured by the customer), use the cache service 155 when responding to the inference request. The cache service 155 can include a cached distributed data store 157 storing previous inference requests and any corresponding inference responses. In one embodiment, the cached distributed data store 157 is a key-value store that stores a hash of previous inference queries with corresponding inference responses as key-value pairs. The cached distributed data store 157 may be stored on each of the compute servers 110A-N or at least some of the compute servers 110A-N. The contents of the cached distributed data store 157 may be different on different ones of the compute servers 110A-N. For instance, it is possible for a cached distributed data store 157 on a first compute server to have inference request and response pairs and a cached distributed data store 157 on a second compute server having no inference request and response pairs or different inference request and response pairs.

In some embodiments, the cache service 155 stores inference request and response pairs in the cached distributed data store 157 up through a TTL, where upon expiration of the TTL, those inference request and response pairs are subject to removal from the cached distributed data store 157. In one embodiment, the TTL for the storing of inference request and response pairs is set at a default of two weeks. In other embodiments, inference requests and responses are stored in the cached distributed data store 157 until the cache service 155 receives a notification or indication that the AI model that generated the inference response is updated.

In some embodiments, the cache check determines if an exact match to the inference request 160 is stored in the cached distributed data store 157. In other embodiments, the cache check performs a similarity matching to determine if the inference request 160 is similar to previous inference requests stored in the cached distributed data store 157. In such embodiments, a similarity setting can be provided to allow a user or administrator to configure a level of similarity desired between the inference request 160 and the previous inference requests. In other embodiments, the cache check can identify previous inference requests that have a similar format from a same or similar application to the inference request 160.

The model control 141, which is optional in some embodiments, can dynamically be used to determine whether function calling is appropriate and which model and/or model size is to be used for processing the request. In an embodiment, the model control 141 runs (e.g., through the model server 145) a relatively simple and fast model (referred herein as a “draft” model) to classify the contents of the inference request and determine whether function calling is appropriate and which model and/or size of model to run for the request. The draft model analyzes the input of the inference request (e.g., the text, the image content or resolution, and/or the audio or video content and complexity) to make this prediction. Such a draft model may be used to determine a recommendation on the function(s) that should be called, if any. Such a recommendation can be provided to the AI model as a hint.

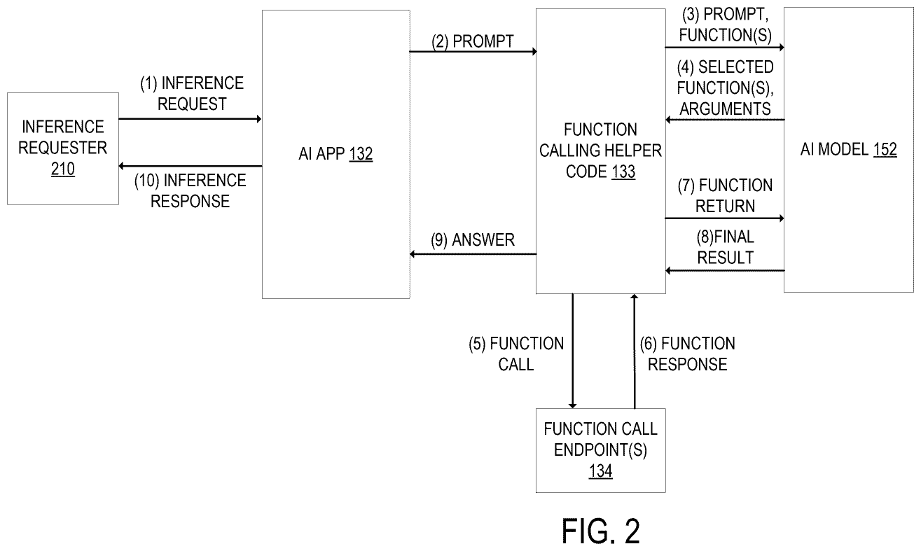

FIG. 2 illustrates an example of the function calling according to embodiments described herein. In the example of FIG. 2, the AI application 132 and the function calling helper code 133 can be executed in the same execution environment (e.g., the same isolate). In an embodiment, the AI model 152 is executed within the same datacenter as the AI application 132 and the function calling helper code 133. In such an embodiment, the AI model 152 may be executed on the same physical machine (e.g., the same server) as the AI application 132 and the function calling helper code 133.

The AI application 132 receives an inference request that originates from the inference requester 210 at operation 1. The inference requester 210 may be a client device (e.g., a smartphone, a tablet, a desktop computer, a laptop computer, a smartwatch, a game console, an Internet of Things (IoT) device, a wearable device, or other computing device) or other device running a software entity (e.g., a piece of code running internal or external to the distributed cloud computing network 105). The inference request includes a user prompt (the input or query that the AI model is to respond to) and may include a system prompt that provides the AI model with instructions, context, or background information that is used by the AI model when generating a response. In the example of FIG. 2, the inference request is for the AI model 152.

In the example of FIG. 2, the AI application 132 is configured for function calling with the AI model 152. For instance, one or more functions have been defined and the corresponding function code to be executed has been defined. The AI application 132 is configured to call or otherwise reference the function calling helper code 133. The AI application 132 transmits the user prompt and any system prompt to the function calling helper code 133 at operation 2. As an example, the prompt may be passed through an argument in a function call to the function calling helper code 133.

The function calling helper code 133 transmits the prompt received from the AI application 132 and one or more function definitions to the AI model 152 at operation 3. The function calling helper code 133 may transmit this information in an inference request to the AI model 152. This inference request may include a system prompt provided by the function calling helper code 133 that provides the AI model 152 with instructions or context for performing a function call. This system prompt can be defined by the service provider of the distributed cloud computing network 105 and/or it can be provided by the entity associated with the AI application 132.

The AI model 152 processes the inference request and determines the function to call and its arguments to call. At operation 4, the AI model 152 transmits a response to the inference request to the function calling helper code 133, where the response identifies the function(s) to call and the arguments to pass to the function (e.g., in a structured format such as JSON).

The function calling helper code 133 receives the inference response from the AI model 152. The function calling helper code 133 performs the function call(s) as specified in the inference response. The function execution can be internal to the distributed cloud computing network 105 or can be external to the distributed cloud computing network 105 (e.g., an external API call). In the example of FIG. 2, the function execution is provided by a function call endpoint 134 that is external to the distributed cloud computing network 105. Thus, at operation 5, the function calling helper code 133 makes a function call passing in the arguments provided by the AI model 152 to a function call endpoint 134 (e.g., an external API call). The function call endpoint 134 executes the function and returns the response back to the function calling helper code 133 at operation 6.

The function calling helper code 133 receives the response from the function call endpoint 134 and transmits another inference request to the AI model 152 at operation 7. This inference request includes the result of the executed function(s). This inference request may also include context for the AI model 152 that this inference request includes the response from a function call. The AI model 152 receives the inference request and processes the inference request. In this example, the AI model 152 parses the response in a natural language and returns an inference response to the function calling helper code 133 at operation 8. This answer is passed back to the AI application 132 at operation 9.

The AI application 132 further processes the answer. The AI application 132 may be configured to return the result of the function calling to the requester and/or take further action based on the result. In the example shown in FIG. 2, the AI application 132 provides the inference response back to the inference requester 210 at operation 10. Alternatively, or in addition, the AI application 132 may take further action based on the answer received from the AI Model 152, as previously described.

In some examples, the operations of FIG. 2 can be understood in the context of the MCP framework. For example, the AI application 132 can implement an MCP client and one or more of function call endpoint(s) 134 can implement MCP servers, as described elsewhere herein. Here, the AI application 132 (acting as an MCP client) can establish a connection with a function call endpoint 134 (acting as an MCP server) to discover the capabilities (tools, data sources, etc.) available from the MCP server. The response from the MCP server contains a list of tool definitions, conforming to the protocol's specification, enabling the MCP client to know how to interact with the MCP server. As indicated, the MCP server can be an application that is either external to distributed cloud computing network 105 or an application running on a compute server 110A-N.

In this MCP example, the inference request at operation 1 can be a request to the AI application 132 from an end-user application (e.g., an AI chat application, developer tool, etc.). The AI application 132 then uses the AI Model 152 to process the request and determine an appropriate action. For example, if the end-user application sends a prompt such as “What is the status of my order?”, the AI application 132 can pass this prompt, along with definitions of available tools, to the AI Model 152. The AI Model 152 processes this input and returns a response to the AI application 132, indicating that a function should be called. The AI application 132 then acts on this instruction by making an invocation call to the specific function call endpoint 134 (the MCP server) that provides the identified tool, passing any arguments identified by the AI Model 152 response.

In some examples, the function call endpoint 134 executes the requested tool (e.g., by querying an external API, database, or other service) and returns a result to the AI application 132. The AI application 132 can then send the result obtained from the function call endpoint 134 and original prompt to the AI Model 152 in order for the model to formulate a natural-language response. The AI application 132 can then send the natural-language response back to the end-user application that initiated the request.

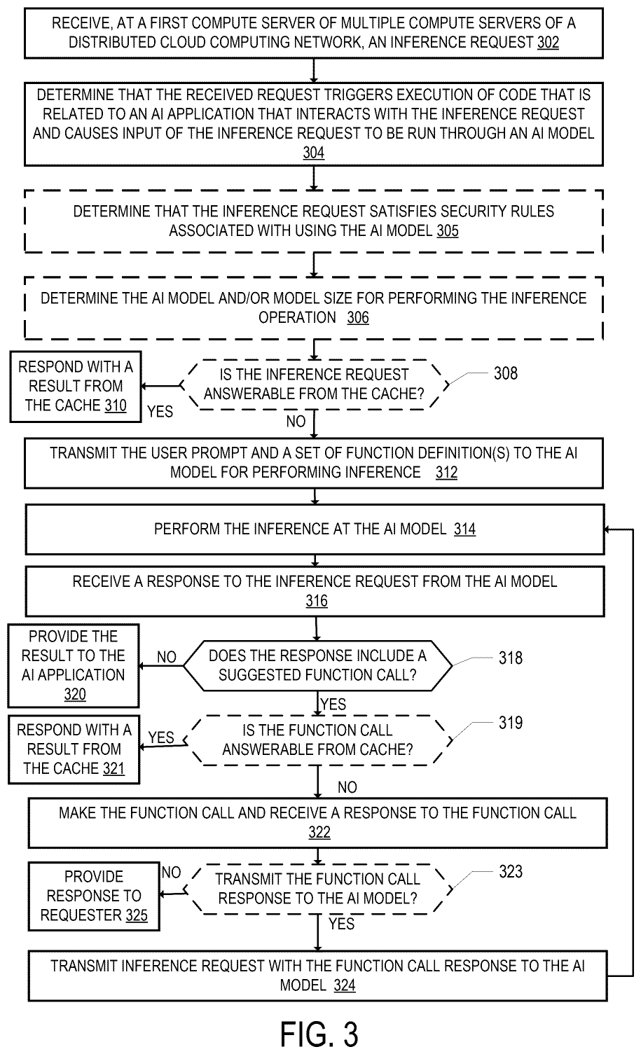

FIG. 3 is a flow diagram that illustrates exemplary operations for processing inference requests at a distributed cloud computing network according to an embodiment. The operations of FIG. 3 will be described with reference to the exemplary embodiment of FIG. 1. However, the operations of FIG. 3 can be performed by embodiments other than those discussed with reference to FIG. 1, and the embodiments discussed with reference to FIG. 1 can perform operations different than those discussed with reference to FIG. 3. In an embodiment, with reference to FIG. 3, the AI application 132 and the function calling helper code 133 can be executed in the same execution environment (e.g., the same isolate). The AI model 152 is executed within the same datacenter as the AI application 132 and the function calling helper code 133. The AI model 152 can be executed on the same physical machine (e.g., the same server) as the AI application 132 and the function calling helper code 133.

At operation 302, a compute server (e.g., compute server 110A) of the compute servers 110A-N of the distributed cloud computing network 105 receives an inference request. The inference request includes input or a reference to input that is to be provided to an AI model for performing an inference operation. Such input may include text, image(s), video(s), and/or audio. The inference request includes a user prompt (the input or query that the AI model is to respond to) and may include a system prompt that provides the AI model with instructions, context, or background information that is used by the AI model when generating a response. The inference request may include a prompt that is suitable to be answered with a function call.

Next, at operation 304, the compute server determines that the received request triggers execution of code that is related to an AI application (e.g., the AI application 132) that interacts with the inference request and causes input of the inference request to be run through an AI model. The code may be third-party code written or deployed by a customer of the distributed cloud computing network and/or first-party code written or deployed by the provider of the distributed cloud computing network. The code may be part of a serverless application. The code can be, for example, a piece of JavaScript or other interpreted language, a WebAssembly (WASM) compiled piece of code, or other compiled code. In an embodiment, the code is compliant with the W3C standard Service Worker API. The AI application may be run in an isolated execution environment and not a virtual machine or a container. However, in other embodiments, the code is executed using a virtual machine or a container.

The AI application 132 is configured for function calling with the AI model. For instance, one or more functions have been defined and the corresponding function code to be executed has been defined. The function(s) and function code may be defined by the customer, uploaded by the customer (which may be custom by the customer or provided by a third party), and/or defined by the service provider of the distributed cloud computing network 105. The AI application 132 is configured to call or otherwise reference the function calling helper code 133.

Next, at operation 305, which is optional in some embodiments, the compute server enforces one or more access rules to determine that access is allowed for the AI application. In some embodiments, the access rules for the AI model are based on an allowlist and/or a denylist. The access rules may be based on identity-based access rules and/or non-identity based access rules applied to characteristics of the inference request. For example, an identity-based access rule may define user identifiers and email addresses or groups of email addresses that are allowed and/or not allowed access to the AI application. A non-identity based access rule is an access rule that is not based on identity of the user, such as location (e.g., geographic region such as the country of origin), device posture, time of request, type of request, IP address, multifactor authentication status, multifactor authentication type, type of device, type of client network application, whether the request is associated with a gateway agent on the client device, and/or other layer 3, layer 4, and/or layer 7 policies. If access was determined to not be allowed, then the request may be dropped.

The AI model that is used can be defined by the AI application. However, at operation 306, which is optional in some embodiments, the model control 141 determines whether function calling is appropriate and which model and/or model size is to be used for processing the request. In an embodiment, the model control 141 runs (e.g., through the model server 145) a relatively simple and fast model (referred herein as a “draft” model) to classify the contents of the inference request and determine whether function calling is appropriate and which model and/or size of model to run for the request. The draft model analyzes the input of the inference request (e.g., the text, the image content or resolution, and/or the audio or video content and complexity) to make this prediction. Such a draft model may be used to determine a recommendation on the function(s) that should be called, if any. Such a recommendation can be provided to the AI model as a hint.

Next, at operation 308, which is optional in some embodiments, the compute server determines whether the inference request (with the determined model) is answerable from the cache. For example, the cache service 155 is checked for a suitable cached response. In an embodiment, the cache key is based on an exact match to the inference request. In another embodiment, a similarity matching is performed to determine if the received inference request is similar to previous inference requests. In such embodiments, a similarity setting can be provided to allow a user or administrator to configure a level of similarity desired between the inference request 160 and the previous inference requests. If the inference request is answerable from the cache, then the compute server responds with a result from the cache at operation 310. This result can be provided to the AI application 132 for structuring and sending a response and/or further processing. If the inference request is not answerable from the cache, then operation 312 is performed.

At operation 312, the function calling helper code 133 transmits the prompt from the initial inference request to the AI model 152 for performing inference. In addition, the function calling helper code 133 transmits a set of one or more function definitions to the AI model 152. The prompt may also include a system prompt provided by the function calling helper code 133 that provides the AI model 152 with instructions or context for performing a function call. To send this inference request to the AI model 152, a request may be made to the model server 145 running on the compute server to perform the inference operation. The request to the model server 145 includes the input and specifies the model that is to be used. The AI model 152 may be executing on the same compute server as the function calling helper code 133. The function calling helper code 133 may be executed in the same isolated execution environment as the AI application.

Next, at operation 314, the inference operation is performed by the AI model 152. Depending on the user prompt, the AI model 152 can determine whether to respond with a suggestion to make a function call along with the arguments. Next, at operation 316, a response to the inference operation is received from the AI model 152 by the function calling helper code 133. Next, at operation 318, the function calling helper code 133 determines whether the response includes a suggested function call. A suggested function call identifies the function(s) to call and the arguments to pass to the function (e.g., in a structured format such as JSON). If it is determined that the response includes a suggested function call, then operation 319 is performed (which is optional). If it is determined that the response does not include a suggested function call, then operation 320 is performed where the result of the inference request is provided to the AI application 132. The AI application 132 can use the result for structuring and sending a response to the requester.

At operation 319, the function calling helper code 133 determines whether the function call is answerable from cache. Some function calls can be cached such as deterministic functions that return the same output for a given input (e.g., mathematical calculations, data transformations), stable data where it is expected that data does not change (e.g., fetching historical information), and frequently accessed information that does not change often. Some other function calls are not appropriate for caching such as non-deterministic functions (e.g., functions depending on the current time), data that changes rapidly (e.g., real-time weather, stock prices), functions that deal with security-sensitive operations such as authentication or authorization, functions that deal with dynamic content (e.g., shopping cart contents), and functions that modify data or state (e.g., writing to a database). Some function calls can be cached for a relatively short period (e.g., 30 seconds, 5 minutes). If the function call is answerable from cache (e.g., the response is in cache), then operation 321 is performed where the function calling helper code 133 responds with the result from the cache. This result can be provided to the AI application 132 for structuring and sending a response and/or further processing. If the function call is not answerable from cache (e.g., the response is not in cache), then operation 322 is performed.

At operation 322 (the response from the AI model 152 included a suggested function call and it was not answerable from cache), the function calling helper code 133 makes the function call and receives a response to the function call. The function call may be made to an external endpoint (e.g., an external API), such as a function call endpoint 134. The function call may alternatively be internal to the distributed cloud computing network 105. If the response includes multiple suggested function calls, the function calling helper code 133 can make each suggested function call. In an embodiment, prior to making a suggested function call, the function calling helper code 133 validates the function call with the requester (e.g., presents the suggestion to the requester and only proceeds if the requester confirms the function). The function calling helper code 133 may cause the response to be cached.

Some responses to functions are sent back to the AI model for further processing while other responses are not. This decision may depend on the nature of the function, the intent of the inference request, and/or the response of the function call. As an example, the function response may not be sent to the AI model if the action of the function does not require the AI model for processing (e.g., writing to a database, sending an email). Such a function response may be a Boolean or status code that indicates whether the operation was successful. As another example, the function response may be sent to the AI model if the intent of the inference request is to receive a response from the AI model itself. In this scenario, the function call result is returned to the AI model for integration into its response or further processing.

At operation 323, the function calling helper code 133 determines whether to transmit the function call response to the AI model 152. If it determines not to transmit the function call response to the AI model 152, then operation 325 is performed where a response is provided to the requester. For example, the AI application 132 may transmit a response to the requester indicating that the function was performed (and what was performed). If, for example, the function call wrote something to the database, the AI application may transmit a response back to the requester that indicates that the information was written to the database (and may specify what information was written). If the determination is to transmit the function call response to the AI model, then at operation 324, the function calling helper code 133 transmits another inference request with the response from the function call to the AI model 152. Flow then moves back to operation 314. In this manner, the AI model 152 can parse the function call response and returns a response in a natural language that can be provided by the AI application. In an embodiment, the raw result of the function call may be preserved for viewing by the customer or user.

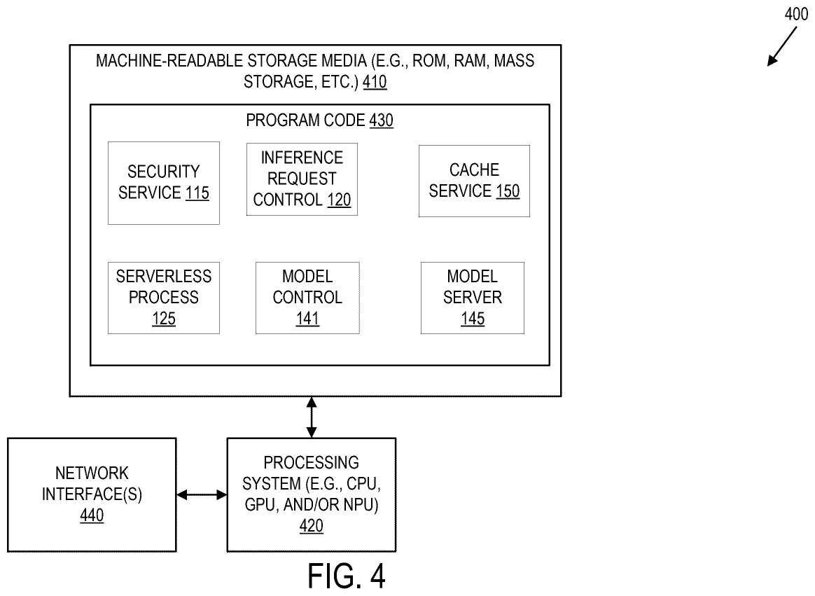

FIG. 4 illustrates a block diagram for an exemplary data processing system 400 that may be used in some embodiments. One or more such data processing systems 400 may be utilized to implement the embodiments and operations described with respect to the compute servers. The data processing system 400 is an electronic device that stores and transmits (internally and/or with other electronic devices over a network) code (which is composed of software instructions and which is sometimes referred to as computer program code or a computer program) and/or data using machine-readable media (also called computer-readable media), such as machine-readable storage media 410 (e.g., magnetic disks, optical disks, read only memory (ROM), flash memory devices, phase change memory) and machine-readable transmission media (also called a carrier) (e.g., electrical, optical, radio, acoustical or other form of propagated signals-such as carrier waves, infrared signals), which is coupled to the processing system 420. The processing system 420 can include CPU(s), GPU(s), and/or other processors. For example, the depicted machine-readable storage media 410 may store program code 430 that, when executed by the processing system 420, causes the data processing system 400 to execute the security service 115, inference request control 120, serverless process 125, model control 141, model server 145, and/or the cache service 155, and/or any of the operations described herein. The data processing system 400 also includes one or more network interfaces 440 (e.g., a wired and/or wireless interfaces) that allows the data processing system 400 to transmit data and receive data from other computing devices, typically across one or more networks (e.g., Local Area Networks (LANs), the Internet, etc.). Additional components, not shown, may also be part of the system 400, and, in certain embodiments, fewer components than those shown. One or more buses may be used to interconnect the various components shown in FIG. 4.

The techniques shown in the figures can be implemented using code and data stored and executed on one or more electronic devices (e.g., a client device, a compute server, a control server). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals-such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device.

In the preceding description, numerous specific details are set forth to provide a more thorough understanding. However, embodiments may be practiced without such specific details. In other instances, full software instruction sequences have not been shown in detail to not obscure understanding. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method, comprising:
receiving, at a compute server of a plurality of compute servers of a distributed cloud computing network that includes a plurality of datacenters, a first inference request, wherein the compute server is part of a first one of the plurality of datacenters, and wherein the first inference request is received from a first entity;
determining that the received first inference request triggers execution of first code at the distributed cloud computing network, wherein the first code is related to an artificial intelligence (AI) application that interacts with the first inference request and causes input of the first inference request to be run through an AI model;
transmitting, from helper code executing on the compute server, a second inference request to the AI model, wherein the second inference request includes a prompt and one or more function definitions, wherein the AI model is executing in the first one of the plurality of datacenters;
receiving, at the helper code, a first result of executing the second inference request, wherein the first result of executing the second inference request includes structured data for calling a function;
calling, by the helper code, the function using the structured data included in the result of executing the second inference request;
receiving, at the helper code, a response to the called function; and
processing, at the first code, a response to the received first inference request based at least on the received response to the called function.

2. The method of claim 1, further comprising:
wherein prior to the processing the response to the received first inference request, performing:
transmitting, from the helper code, a third inference request to the AI model, wherein the third inference request includes data from the response to the called function;
receiving, at the helper code, a second result of executing the third inference request; and
transmitting the second result to the first code;
wherein processing, at the first code, the response to the received first inference request includes the second result.

3. The method of claim 1, wherein the AI model is executing on the compute server.

4. The method of claim 1, wherein calling the function includes transmitting an HTTP request to a server that is external to the distributed cloud computing network, and wherein receiving the response to the called function includes receiving an HTTP response from the server.

5. The method of claim 1, wherein processing, at the first code, the second result includes manipulating data based on the second result at a database.

6. The method of claim 1, further comprising:
automatically creating the one or more function definitions prior to transmitting the one or more function definitions to the AI model, wherein the one or more function definitions are automatically created from a library or specification.

7. The method of claim 1, wherein the first code is a Model Context Protocol (MCP) client that receives the first inference request from an application, and wherein calling the function comprises the MCP client transmitting an invocation call to an MCP server.

8. A non-transitory machine-readable storage medium of a compute server that provides instructions that, if executed by a processing system, will cause the processing system to perform operations including:
receiving, at the compute server of a plurality of compute servers of a distributed cloud computing network that includes a plurality of datacenters, a first inference request, wherein the compute server is part of a first one of the plurality of datacenters, and wherein the first inference request is received from a first entity;
determining that the received first inference request triggers execution of first code at the distributed cloud computing network, wherein the first code is related to an artificial intelligence (AI) application that interacts with the first inference request and causes input of the first inference request to be run through an AI model;
transmitting, from helper code executing on the compute server, a second inference request to the AI model, wherein the second inference request includes a prompt and one or more function definitions, wherein the AI model is executing in the first one of the plurality of datacenters;
receiving, at the helper code, a first result of executing the second inference request, wherein the first result of executing the second inference request includes structured data for calling a function;
calling, by the helper code, the function using the structured data included in the result of executing the second inference request;
receiving, at the helper code, a response to the called function; and
processing, at the first code, a response to the received first inference request based at least on the received response to the called function.

9. The non-transitory machine-readable storage medium of claim 8, wherein the operations further include:
wherein prior to the processing the response to the received first inference request, performing:
transmitting, from the helper code, a third inference request to the AI model, wherein the third inference request includes data from the response to the called function;
receiving, at the helper code, a second result of executing the third inference request; and
transmitting the second result to the first code;
wherein processing, at the first code, the response to the received first inference request includes the second result.

10. The non-transitory machine-readable storage medium of claim 8, wherein the AI model is executing on the compute server.

11. The non-transitory machine-readable storage medium of claim 8, wherein calling the function includes transmitting an HTTP request to a server that is external to the distributed cloud computing network, and wherein receiving the response to the called function includes receiving an HTTP response from the server.

12. The non-transitory machine-readable storage medium of claim 8, wherein processing, at the first code, the second result includes manipulating data based on the second result at a database.

13. The non-transitory machine-readable storage medium of claim 8, wherein the operations further include:
automatically creating the one or more function definitions prior to transmitting the one or more function definitions to the AI model, wherein the one or more function definitions are automatically created from a library or specification.

14. The non-transitory machine-readable storage medium of claim 8, wherein the first code is a Model Context Protocol (MCP) client that receives the first inference request from an application, and wherein calling the function comprises the MCP client transmitting an invocation call to an MCP server.

15. A compute server, comprising:
a processor; and
a non-transitory machine-readable storage medium that provides instructions that, if executed by the processor, will cause the compute server to perform operations including:
receiving, at the compute server of a plurality of compute servers of a distributed cloud computing network that includes a plurality of datacenters, a first inference request, wherein the compute server is part of a first one of the plurality of datacenters, and wherein the first inference request is received from a first entity;
determining that the received first inference request triggers execution of first code at the distributed cloud computing network, wherein the first code is related to an artificial intelligence (AI) application that interacts with the first inference request and causes input of the first inference request to be run through an AI model;
transmitting, from helper code executing on the compute server, a second inference request to the AI model, wherein the second inference request includes a prompt and one or more function definitions, wherein the AI model is executing in the first one of the plurality of datacenters;
receiving, at the helper code, a first result of executing the second inference request, wherein the first result of executing the second inference request includes structured data for calling a function;
calling, by the helper code, the function using the structured data included in the result of executing the second inference request;
receiving, at the helper code, a response to the called function; and
processing, at the first code, a response to the received first inference request based at least on the received response to the called function.

16. The compute server of claim 15, wherein the operations further include:
wherein prior to the processing the response to the received first inference request, performing:
transmitting, from the helper code, a third inference request to the AI model, wherein the third inference request includes data from the response to the called function;
receiving, at the helper code, a second result of executing the third inference request; and
transmitting the second result to the first code;
wherein processing, at the first code, the response to the received first inference request includes the second result.

17. The compute server of claim 15, wherein the AI model is executing on the compute server.

18. The compute server of claim 15, wherein calling the function includes transmitting an HTTP request to a server that is external to the distributed cloud computing network, and wherein receiving the response to the called function includes receiving an HTTP response from the server.

19. The compute server of claim 15, wherein processing, at the first code, the second result includes manipulating data based on the second result at a database.

20. The compute server of claim 15, wherein the operations further include:
automatically creating the one or more function definitions prior to transmitting the one or more function definitions to the AI model, wherein the one or more function definitions are automatically created from a library or specification.

21. The compute server of claim 15, wherein the first code is a Model Context Protocol (MCP) client that receives the first inference request from an application, and wherein calling the function comprises the MCP client transmitting an invocation call to an MCP server.
